(19) United States
(12) Patent Application Publication
(10) Pub. No.: US 2006/0080244 A1
(43) Pub. Date: Apr. 13, 2006

(54) Method and apparatus for insuring and paying annuities for patents

(76) Inventor: Steven Lundberg, Edina, MN (US)

Correspondence Address: Schwegman, Lundberg, Woessner & Kluth, P.A., P.O. Box 2938, Minneapolis, MN, 55402, US

(21) Appl. No.: 11/219,087

(22) Filed: Sep. 1, 2005

Related U.S. Application Data
(60) Provisional application No. 60/606,299, filed on Sep. 1, 2004.

(51) Int. Cl. G06Q 40/00

(52) U.S. Cl. 705/40

(57) ABSTRACT

Systems and methods are described that allow and enable the provision of malpractice or errors and omissions insurance to cover malpractice or other negligent conduct in connection with the payment of annuity or maintenance fees for patents and patent applications throughout the world

This application claims the benefit of priority, under 35 U.S.C. Section 119(e), to U.S. Provisional Application No. 60/606,299, filed Sep. 1, 2004, which is incorporated herein by reference.

### TECHNICAL FIELD OF THE INVENTION

This inventive subject matter pertains generally to insurance and more particularly to methods and systems for insuring losses in connection with payment of annuity or maintenance fees for patents and patent applications.

### BACKGROUND

The liability associated with the failure to properly pay an annuity or maintenance or maintenance fee appears to be growing dramatically in recent years. Most law firms have malpractice insurance that covers the law firm's liability for failure to properly pay such fees, up to a limit. However, this insurance may not be billable to a client directly as it is not attributable to a particular service provided, such as the service of tracking and paying maintenance or annuity fees.

### BRIEF DESCRIPTION OF THE DRAWINGS

FIGS. 1 through 6 show various embodiments of the inventive subject matter.

### DETAILED DESCRIPTION

Set forth below are various embodiments of the inventive subject matter. According to at least some of these embodiments there is provided method and apparatus allowing and enabling the provision of malpractice or errors and omissions insurance to cover malpractice or other negligent conduct in connection with the payment of annuity or maintenance fees for patents and patent applications throughout the world. Such patents or patent applications are identified herein as “patent rights”, and include utility, design, petty, model or any other form of patent protection. An annuity or maintenance fee is a tax or other government fee assessed in order to maintain an application or patent in good standing or in force.

According to one example embodiment of the inventive subject matter there is provided a method including:
identifying a patent right for which an annuity or maintenance payment is due;
providing liability insurance to cover damages incurred in the event a responsibility to process the annuity or maintenance payment is not properly handled or paid by a law firm or other service provider;
charging an insurance fee for the liability insurance; and
billing an owner of the patent right for the insurance fee.

According to another example embodiment, the method further includes billing a law firm responsible for causing the annuity or maintenance payment to be paid.

According to another example embodiment of the inventive subject matter there is provided a method including:
identifying a patent right for which an annuity or maintenance payment is due;
providing liability insurance to cover damages incurred in the event a responsibility to process the annuity or maintenance payment is not properly handled or paid by a law firm or other service provider;
charging an insurance fee for the liability insurance;
billing a law firm responsible for causing the annuity or maintenance payment to be paid; and
the law firm billing an owner of the patent right for the insurance fee.

According to still another example embodiment of the inventive subject matter there is provided a method including:
maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights; and
billing an owner of each of the patent rights for the insurance fee.

According to still another example embodiment of the method it includes billing a law firm responsible for causing the annuity or maintenance payment to be paid, wherein the law firm is billed a separate insurance fee for each of the patent rights.

According to yet another example embodiment of the inventive subject matter there is provided a method including:
maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights;
billing a law firm responsible for causing the annuity or maintenance payment to be paid, wherein the law firm is billed a separate insurance fee for each of the patent rights; and
billing an owner of each of the patent rights for the insurance fee.

According to yet one more example embodiment of the inventive subject matter there is provided a method including:
a law firm or annuity or maintenance payment provider maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights;
billing a law firm responsible for causing the annuity or maintenance payment to be paid, wherein the law firm is billed a separate insurance fee for each of the patent rights;
billing an owner of each of the patent rights for the insurance fee; and
the insurance provider verifying that the annuity or maintenance payments have been properly paid in accordance with instructions from an authorized party.

According to still one more example embodiment, the method further includes the insurance provider paying an annuity or maintenance payment that is not properly verified as not to be paid.

According to still another example embodiment the method includes the insurance provider paying damages to a patent owner on an insured annuity or maintenance payment if the annuity or maintenance payment is not properly paid.

According to still yet another example embodiment the method includes the insurance for the annuity or maintenance payment processing is in addition to a malpractice policy held by a law firm for the purpose of covering liability for malpractice attributable to other professional services provided by the law firm.

According to still another example embodiment there is provided apparatus including one or more computer systems including software program components adapted to:
identify a patent right for which an annuity or maintenance payment is due;
track a liability insurance coverage provided to cover damages incurred in the event a responsibility to process the annuity or maintenance payment is not properly handled or paid by a law firm or other service provider;
record a charge for an insurance fee for the liability insurance; and
record a billing to an owner of the patent right for the insurance fee.

According to still yet another example embodiment the system includes the software computer program components adapted to record a billing to a law firm responsible for causing the annuity or maintenance payment to be paid.

According to still another example embodiment there is provided apparatus including one or more computer systems including software program components adapted to:
identify a patent right for which an annuity or maintenance payment is due;
track a liability insurance coverage provided to cover damages incurred in the event a responsibility to process the annuity or maintenance payment is not properly handled or paid by a law firm or other service provider;
record a charge for an insurance fee for the liability insurance;
bill to a law firm responsible for causing the annuity or maintenance payment to be paid; and
record a law firm charge to an owner of the patent right for the insurance fee.

According to still another example embodiment there is provided apparatus including one or more computer systems including software program components adapted to:
maintain a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
record a charge of an insurance fee for the liability insurance for each of the plurality of patent rights; and
bill an owner of each of the patent rights for the insurance fee.

According to still yet another example embodiment the system includes the software computer program components adapted to bill a law firm responsible for causing the annuity or maintenance payment to be paid, wherein the law firm is billed a separate insurance fee for each of the patent rights.

According to still another example embodiment there is provided apparatus including one or more computer systems including software program components adapted to:
maintain a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
charge an insurance fee for the liability insurance for each of the plurality of patent rights;
bill a law firm responsible for causing the annuity or maintenance payment to be paid, wherein the law firm is billed a separate insurance fee for each of the patent rights; and
bill an owner of each of the patent rights for the insurance fee.

According to still another example embodiment there is provided apparatus including one or more computer systems including software program components adapted to:
bill a law firm or annuity or maintenance payment provider maintaining a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
charge an insurance fee for the liability insurance for each of the plurality of patent rights;
bill a law firm responsible for causing the annuity or maintenance payment to be paid, wherein the law firm is billed a separate insurance fee for each of the patent rights;
bill an owner of each of the patent rights for the insurance fee; and
verify that the annuity or maintenance payments have been properly paid in accordance with instructions from an authorized party.

According to still yet another example embodiment the system includes the software computer program components adapted to authorize payment of an annuity or maintenance payment that is not properly verified as not to be paid.

According to yet another example embodiment the system includes the software computer program components adapted to record payment by the insurance provider of damages to a patent owner on an insured annuity or maintenance payment.

According to yet one more example embodiment of the inventive subject matter there is provided a method including:
providing liability insurance to cover damages incurred in the event a responsibility to process the annuity or maintenance payment is not properly handled or paid by a law firm or other service provider; and
charging an insurance fee for the liability insurance that is based on one or parameters related to the quantity or value of annuity payments handled by the law firm or other service provider.

According to another example embodiment the method includes billing an owner of the patent right for all or a portion of the insurance fee.

According to another example embodiment the method includes the liability insurance is provided as a rider to a general liability malpractice policy for the law firm.

According to another example embodiment the method includes the liability insurance is provided as a rider to a general liability errors or omissions policy for the law firm.

According to another example embodiment the method includes billing the law firm for the insurance fee such that a separate insurance fee is assessed for each matter handled by the firm.

According to another example embodiment the method includes the law firm billing its clients for the separate insurance fees for each matter the fee is charged for.

According to another example embodiment the method includes the separate insurance fees being billed as an out-of-pocket cost or disbursement.

According to another example embodiment the method includes the law firm billing an owner of the patent right for all or a portion of the insurance fee.

According to one example embodiment of the inventive subject matter there is provided apparatus wherein one or more computer systems including one or more computer program components to cause the one or more computer systems to:
record the granting of liability insurance to cover damages incurred in the event a responsibility to process the annuity or maintenance payment is not properly handled or paid by a law firm or other service provider; and
bill an insurance fee for the liability insurance that is based on one or parameters related to the quantity or value of annuity payments handled by the law firm or other service provider.

According to one example embodiment of the inventive subject matter the apparatus further includes the software components further adapted to bill an owner of the patent right for all or a portion of the insurance fee.

According to one example embodiment of the apparatus further includes the software components further adapted to record the liability insurance as a rider to a general liability malpractice policy for the law firm.

According to one example embodiment of the apparatus it further provides that the software components are further adapted to record the liability insurance as a rider to a general liability errors or omissions policy for the law firm.

According to one example embodiment of the apparatus the software components are further adapted to bill the law firm for the insurance fee such that a separate insurance fee is assessed for each matter handled by the firm.

According to one more example embodiment of the apparatus it further includes the software components further adapted to bill the law firm clients for the separate insurance fees for each matter the fee is charged for.

According to still one more example embodiment of the apparatus it further includes the software components further adapted to bill the separate insurance fees as an out-of-pocket cost or disbursement.

According to yet another example embodiment of the apparatus further includes the software components further adapted to bill an owner of the patent right for all or a portion of the insurance fee.

According to still another example embodiment of the inventive subject matter there is included a method including:
providing liability insurance to cover damages incurred in the event a responsibility to process the annuity or maintenance payment is not properly handled or paid by a law firm or other service provider;
charging an insurance fee for the liability insurance that is based on one or parameters related to the quantity or value of annuity payments handled by the law firm or other service provider;
notifying the insurance provider or its agent of any annuity payments that will not be paid for a matter handled by the law firm or other service provider;
the insurance company or its agent providing notice to the owner or agent of the matter that the annuity payment is not being paid or has not been paid.

According to yet another example embodiment the method includes billing an owner of the patent right for all or a portion of the insurance fee.

According to still another example embodiment the method includes the liability insurance is provided as a rider to a general liability malpractice policy for the law firm.

According to vet still another example embodiment the method includes the liability insurance is provided as a rider to a general liability errors or omissions policy for the law firm.

According to one more example embodiment the method includes billing the law firm for the insurance fee such that a separate insurance fee is assessed for each matter handled by the firm.

According to yet one more example embodiment the method includes the law firm billing its clients for the separate insurance fees for each matter the fee is charged for.

According to yet still another example embodiment the method includes the separate insurance fees being billed as an out-of-pocket cost or disbursement.

According to one more example embodiment the method includes the law firm billing an owner of the patent right for all or a portion of the insurance fee.

According to still another example embodiment there is provided apparatus including one or more computer systems including one or more computer program components to cause the one or more computer systems to:
record the granting of liability insurance to cover damages incurred in the event a responsibility to process the annuity or maintenance payment is not properly handled or paid by a law firm or other service provider;
bill an insurance fee for the liability insurance that is based on one or parameters related to the quantity or value of annuity payments handled by the law firm or other service provider;
notifying the insurance provider or its agent of any annuity payments that will not be paid for a matter handled by the law firm or other service provider; and
providing notice from the insurance provider or agent to the owner or agent of the matter that the annuity payment is not being paid or has not been paid.

According to yet another example embodiment the apparatus includes the software components further adapted to bill an owner of the patent right for all or a portion of the insurance fee.

According to yet another example embodiment the apparatus includes the software components further adapted to record the liability insurance as a rider to a general liability malpractice policy for the law firm.

According to yet another example embodiment the apparatus includes the software components further adapted to record the liability insurance as a rider to a general liability errors or omissions policy for the law firm.

According to yet another example embodiment the apparatus includes the software components further adapted to bill the law firm for the insurance fee such that a separate insurance fee is assessed for each matter handled by the firm.

According to yet another example embodiment the apparatus includes the software components further adapted to bill the law firm clients for the separate insurance fees for each matter the fee is charged for.

According to yet another example embodiment the apparatus includes the software components further adapted to bill the separate insurance fees as an out-of-pocket cost or disbursement.

According to yet another example embodiment the apparatus includes the software components further adapted to bill an owner of the patent right for all or a portion of the insurance fee.

Thus, as set forth above there are various embodiments of the inventive subject matter providing method and apparatus that provide insurance for malpractice or errors and omissions insurance to cover malpractice or other negligent conduct in connection with the payment of annuity or maintenance fees for patents and patent applications throughout the world. According to one aspect, the insurance is provided as a rider to another general malpractice liability policy. According to another aspect, the insurance is priced based on the number of matters for which annuity or maintenance fees are being handled by the law firm or other service provider. According to still other embodiments, there is provided method and apparatus for providing notice to the owners of the matters for which payments are not being made. This allows the owners or the agents one last chance to identify any error resulting the unintended nonpayment of an annuity, and also provides documentary evidence showing that such notice was provided in the event there is later a dispute concerning whether or not the annuity or maintenance fee was properly not paid. By placing such under the control of the insurance company providing the malpractice insurance, the insurance company minimizes its potential liability for improper non-payment.

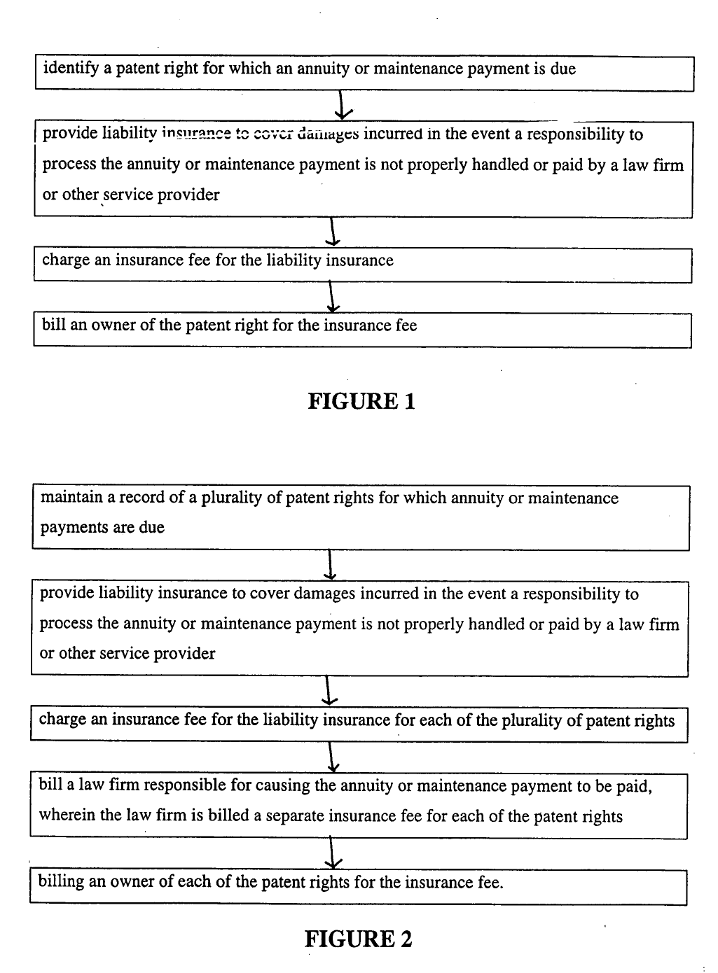

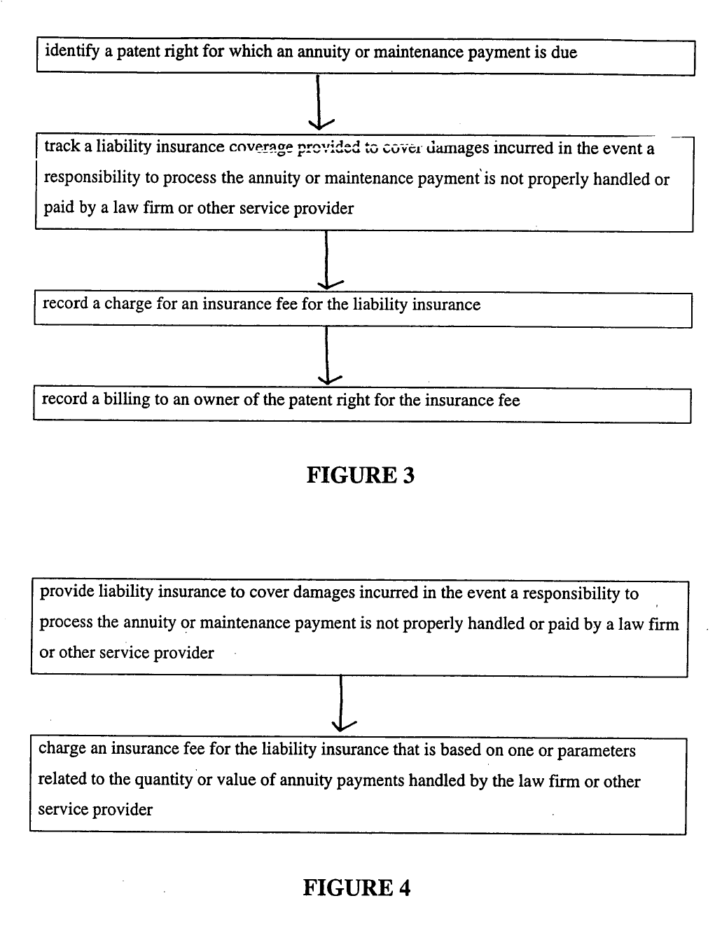

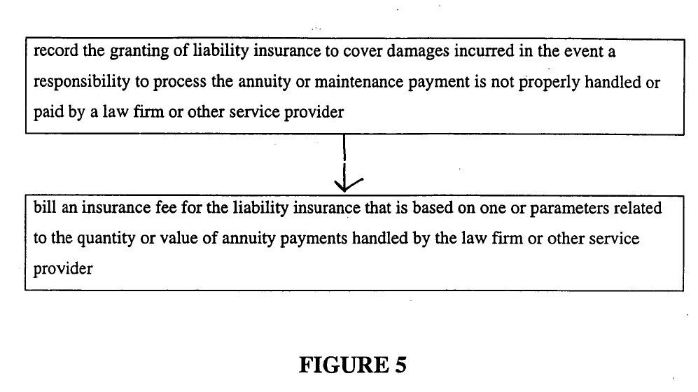

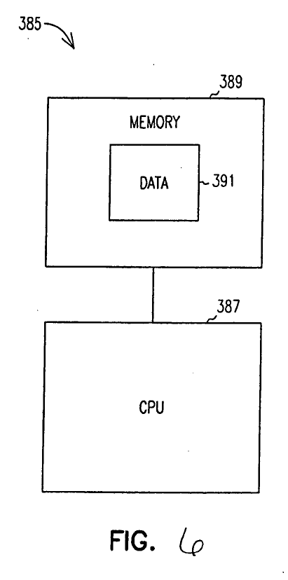

FIGS. 1-5 are flow diagrams illustrating several example methods according to various embodiments of the inventive subject matter. The methods described in this detailed description or shown in the Figures do not have to be executed in the order described, or in any particular order. Moreover, various activities described with respect to the methods identified herein can be executed in repetitive, serial, or parallel fashion. Information, including parameters, commands, operands, and other data, can be sent and received over a wired or wireless communication network.

Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

FIG. 6 is a block diagram of a system 385 according to various embodiments. Examples of such embodiments may comprise a computer, a memory system, a magnetic or optical disk, some other storage device, or any type of electronic device or system. The system 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) performing the methods described herein.

What is claimed is:

1. A method comprising:
identifying a patent right for which an annuity or maintenance payment is due;
providing liability insurance to cover damages incurred in the event a responsibility to process the annuity or maintenance payment is not properly handled or paid by a law firm or other service provider;
charging an insurance fee for the liability insurance; and
billing an owner of the patent right for the insurance fee.

2. A method according to claim 1 further including billing a law firm responsible for causing the annuity or maintenance payment to be paid.

3. A method comprising:
identifying a patent right for which an annuity or maintenance payment is due;
providing liability insurance to cover damages incurred in the event a responsibility to process the annuity or maintenance payment is not properly handled or paid by a law firm or other service provider;
charging an insurance fee for the liability insurance;
billing a law firm responsible for causing the annuity or maintenance payment to be paid; and
the law firm billing an owner of the patent right for the insurance fee.

4. A method comprising:
maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights; and
billing an owner of each of the patent rights for the insurance fee.

5. A method according to claim 4 further including billing a law firm responsible for causing the annuity or maintenance payment to be paid, wherein the law firm is billed a separate insurance fee for each of the patent rights.

6. A method comprising:
maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights;
billing a law firm responsible for causing the annuity or maintenance payment to be paid, wherein the law firm is billed a separate insurance fee for each of the patent rights; and
billing an owner of each of the patent rights for the insurance fee.

7. A method comprising:
a law firm or annuity or maintenance payment provider maintaining a record of a plurality of patent rights for which annuity or maintenance payments are due;
providing liability insurance to cover damages incurred in the event a responsibility to process the annuity or maintenance payment is not properly handled or paid by a law firm or other service provider;
charging an insurance fee for the liability insurance for each of the plurality of patent rights;
billing a law firm responsible for causing the annuity or maintenance payment to be paid, wherein the law firm is billed a separate insurance fee for each of the patent rights;
billing an owner of each of the patent rights for the insurance fee; and
the insurance provider verifying that the annuity or maintenance payments have been properly paid in accordance with instructions from an authorized party.

8. A method according to claim 7 further comprising the insurance provider paying an annuity or maintenance payment that is not properly verified as not to be paid.

9. A method according to claim 1 further comprising the insurance provider paying damages to a patent owner on an insured annuity or maintenance payment if the annuity or maintenance payment is not properly paid.

10. A system comprising one or more computer systems including software program components adapted to:
identify a patent right for which an annuity or maintenance payment is due;
track a liability insurance coverage provided to cover damages incurred in the event a responsibility to process the annuity or maintenance payment is not properly handled or paid by a law firm or other service provider;
record a charge for an insurance fee for the liability insurance; and
record a billing to an owner of the patent right for the insurance fee.

11. A system accord to claim 10 further including the software computer program components adapted to record a billing to a law firm responsible for causing the annuity or maintenance payment to be paid.

12. A system comprising one or more computer systems including software program components adapted to:
identify a patent right for which an annuity or maintenance payment is due;
track a liability insurance coverage provided to cover damages incurred in the event a responsibility to process the annuity or maintenance payment is not properly handled or paid by a law firm or other service provider;
record a charge for an insurance fee for the liability insurance;
bill to a law firm responsible for causing the annuity or maintenance payment to be paid; and
record a law firm charge to an owner of the patent right for the insurance fee.

13. A system comprising one or more computer systems including software program components adapted to:
maintain a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
record a charge of an insurance fee for the liability insurance for each of the plurality of patent rights; and
bill an owner of each of the patent rights for the insurance fee.

14. A system accord to claim 13 further including the software computer program components adapted to bill a law firm responsible for causing the annuity or maintenance payment to be paid, wherein the law firm is billed a separate insurance fee for each of the patent rights.

15. A system comprising one or more computer systems including software program components adapted to:
maintain a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
charge an insurance fee for the liability insurance for each of the plurality of patent rights;
bill a law firm responsible for causing the annuity or maintenance payment to be paid, wherein the law firm is billed a separate insurance fee for each of the patent rights; and
bill an owner of each of the patent rights for the insurance fee.

16. A system comprising one or more computer systems including software program components adapted to:
bill a law firm or annuity or maintenance payment provider maintaining a record of a plurality of patent rights for which annuity or maintenance payments are due;
record a liability insurance coverage provided to cover damages incurred in the event a responsibility to process the annuity or maintenance payment is not properly handled or paid by a law firm or other service provider;
charge an insurance fee for the liability insurance for each of the plurality of patent rights;
bill a law firm responsible for causing the annuity or maintenance payment to be paid, wherein the law firm is billed a separate insurance fee for each of the patent rights;
bill an owner of each of the patent rights for the insurance fee; and
verify that the annuity or maintenance payments have been properly paid in accordance with instructions from an authorized party.

17. A system accord to claim 16 further comprising the software computer program components adapted to authorize payment of an annuity or maintenance payment that is not properly verified as not to be paid.

18. A system accord to claim 10 further comprising the software computer program components adapted to record payment by the insurance provider of damages to a patent owner on an insured annuity or maintenance payment.

19. A method according to claim 1 further wherein the insurance for the annuity or maintenance payment processing is in addition to a malpractice policy held by a law firm for the purpose of covering liability for malpractice attributable to other professional services provided by the law firm.

20. A method comprising:
providing liability insurance to cover damages incurred in the event a responsibility to process the annuity or maintenance payment is not properly handled or paid by a law firm or other service provider; and
charging an insurance fee for the liability insurance that is based on one or parameters related to the quantity or value of annuity payments handled by the law firm or other service provider.

21. A method according to claim 20 further including billing an owner of the patent right for all or a portion of the insurance fee.

22. A method according to claim 20 further wherein the liability insurance is provided as a rider to a general liability malpractice policy for the law firm.

23. A method according to claim 20 father wherein the liability insurance is provided as a rider to a general liability errors or omissions policy for the law firm.

24. A method according to claim 20 further including billing the law firm for the insurance fee such that a separate insurance fee is assessed for each matter handled by the firm.

25. A method according to claim 24 further including the law firm billing its clients for the separate insurance fees for each matter the fee is charged for.

26. A method according to claim 25 further including the separate insurance fees being billed as an out-of-pocket cost or disbursement.

27. A method according to claim 20 further including the law firm billing an owner of the patent right for all or a portion of the insurance fee.

28. Apparatus comprising one or more computer systems including one or more computer program components to cause the one or more computer systems to:
record the granting of liability insurance to cover damages incurred in the event a responsibility to process the annuity or maintenance payment is not properly handled or paid by a law firm or other service provider; and
bill an insurance fee for the liability insurance that is based on one or parameters related to the quantity or value of annuity payments handled by the law firm or other service provider.

29. Apparatus according to claim 28 further including the software components further adapted to bill an owner of the patent right for all or a portion of the insurance fee.

30. Apparatus according to claim 28 further including the software components further adapted to record the liability insurance as a rider to a general liability malpractice policy for the law firm.

31. Apparatus according to claim 28 further including the software components further adapted to record the liability insurance as a rider to a general liability errors or omissions policy for the law firm.

32. Apparatus according to claim 28 further including the software components further adapted to bill the law firm for the insurance fee such that a separate insurance fee is assessed for each matter handled by the firm.

33. Apparatus according to claim 32 further including the software components further adapted to bill the law firm clients for the separate insurance fees for each matter the fee is charged for.

34. Apparatus according to claim 33 further including the software components further adapted to bill the separate insurance fees as an out-of-pocket cost or disbursement.

35. Apparatus according to claim 28 further including the software components further adapted to bill an owner of the patent right for all or a portion of the insurance fee.

36. A method comprising:
providing liability insurance to cover damages incurred in the event a responsibility to process the annuity or maintenance payment is not properly handled or paid by a law firm or other service provider;
charging an insurance fee for the liability insurance that is based on one or parameters related to the quantity or value of annuity payments handled by the law firm or other service provider;
notifying the insurance provider or its agent of any annuity payments that will not be paid for a matter handled by the law firm or other service provider; and
the insurance company or its agent providing notice to the owner or agent of the matter that the annuity payment is not being paid or has not been paid.

37. A method according to claim 36 further including billing an owner of the patent right for all or a portion of the insurance fee.

38. A method according to claim 36 father wherein the liability insurance is provided as a rider to a general liability malpractice policy for the law firm.

39. A method according to claim 36 father wherein the liability insurance is provided as a rider to a general liability errors or omissions policy for the law firm.

40. A method according to claim 36 further including billing the law firm for the insurance fee such that a separate insurance fee is assessed for each matter handled by the firm.

41. A method according to claim 40 further including the law firm billing its clients for the separate insurance fees for each matter the fee is charged for.

42. A method according to claim 41 further including the separate insurance fees being billed as an out-of-pocket cost or disbursement.

43. A method according to claim 36 further including the law firm billing an owner of the patent right for all or a portion of the insurance fee.

44. Apparatus comprising one or more computer systems including one or more computer program components to cause the one or more computer systems to:
record the granting of liability insurance to cover damages incurred in the event a responsibility to process the annuity or maintenance payment is not properly handled or paid by a law firm or other service provider;
bill an insurance fee for the liability insurance that is based on one or parameters related to the quantity or value of annuity payments handled by the law firm or other service provider;
notifying the insurance provider or its agent of any annuity payments that will not be paid for a matter handled by the law firm or other service provider; and
providing notice from the insurance provider or agent to the owner or agent of the matter that the annuity payment is not being paid or has not been paid.

45. Apparatus according to claim 44 further including the software components further adapted to bill an owner of the patent right for all or a portion of the insurance fee.

46. Apparatus according to claim 44 further including the software components further adapted to record the liability insurance as a rider to a general liability malpractice policy for the law firm.

47. Apparatus according to claim 44 further including the software components further adapted to record the liability insurance as a rider to a general liability errors or omissions policy for the law firm.

48. Apparatus according to claim 44 further including the software components further adapted to bill the law firm for the insurance fee such that a separate insurance fee is assessed for each matter handled by the firm.

49. Apparatus according to claim 48 further including the software components further adapted to bill the law firm clients for the separate insurance fees for each matter the fee is charged for.

50. Apparatus according to claim 49 further including the software components further adapted to bill the separate insurance fees as an out-of-pocket cost or disbursement.

51. Apparatus according to claim 44 further including the software components further adapted to bill an owner of the patent right for all or a portion of the insurance fee.
